(19) United States
(12) Patent Application Publication
(10) Pub. No.: US 2008/0205269 A1
(43) Pub. Date: Aug. 28, 2008

(54) METHOD AND SYSTEM FOR REROUTING TRAFFIC

(76) Inventors: TSUTOMA KITAMURA, Tokyo (JP); TOSHIYA OKABE, Tokyo (JP)

Correspondence Address: Jackson Chen;NEC Corporation of America, 6535 N. State Hwy. 161, Irving, TX, 75039, US

(21) Appl. No.: 12/036,812

(22) Filed: Feb. 25, 2008

(30) Foreign Application Priority Data
Feb. 27, 2007 (JP) 2007-046921

(51) Int. Cl. G08C 15/00

(52) U.S. Cl. 370/230.1

(57) ABSTRACT

A traffic rerouting method for rerouting traffic to be passed to a receiving end from an old path to a new path includes rerouting the traffic by reducing the amount of traffic passing through the old route while at the same time increasing the amount of traffic passing through the new path.

This application is based upon and claims the benefit of priority from Japanese patent application No. 2007-46921, filed on Feb. 27, 2007, the disclosure of which is incorporated herein in its entirety by reference.

### BACKGROUND OF THE INVENTION

1. Field of the Invention

The present invention relates to a method and system for switching traffic between multiple paths through which packets are transmitted and, in particular, to a traffic rerouting method and system that switch traffic between paths through which packets such as audio and video data that require realtimeness are transmitted.

2. Description of the Related Arts

One may want to reroute packets to be transferred from a first device to a second device from one path, i.e., an old path, to another path, i.e., a new path in a case where multiple paths are provided between the first and second devices. Such rerouting is performed for example when an increase in a bit error rate (BER) on an old path is detected or when a scheduled construction or maintenance is performed. When rerouting is performed in a traffic rerouting system of a related art for rerouting a path used for transmitting packets, first a new path is made operational, then, after the new path becomes operational, service on the old path is interrupted and all traffic are rerouted to the new path. In another related-art traffic rerouting system, traffic is duplicated for a certain period of time after a new path becomes operational, then the same traffic is transmitted over the old and new paths and a receiving end uses the traffic arriving over one of the old and new paths and discards the other traffic.

Some packets such as audio or video data packets require that the packets arrive at a receiving end in the order in which they were sent and variations in delay time of packet transmission from a sending end to a receiving end be small. Such packets will be herein referred to as packets requiring realtimeness and traffic of such packets will be referred to as realtime traffic.

As a document as to a related art of the present invention, Japanese Patent Application Laid-Open No. 2003-69619 (JP-A-2003-069619) discloses a technique that performs partial rerouting in accordance with a reroute request issued from an upstream end node. Japanese Patent Application Laid-Open No. 2004-328049 (JP-A-2004-328049) discloses transmission of packets alternately over redundant paths in order to make it possible to check the integrity of both paths when the redundant paths have been set. Japanese Patent Application Laid-Open No. 2006-180359 (JP-A-2006-180359) discloses a technique for simplifying and increasing the speed of retrieving a packet forwarding table in rerouting while ensuring the order in which packets arrive at a receiving end. Japanese Patent Application Laid-Open No. 10-257071 (JP-A-10-257071) discloses decreasing gradually the transfer rate of ATM (Asynchronous Transfer Mode) cells directed to a primary route while increasing the transfer rate on a secondary route when congestion is likely to occur on one of the nodes on the primary route in an ATM network.

The traffic rerouting systems of the related art described above have a problem that rerouting causes noise when the system is applied to realtime traffic. In general, average delay rapidly changes when switching is made from an old path to a new path because of the differences between the old path and the new path in the length of a transmission link forming each path, and the type and number of relaying devices included in each path. As mentioned earlier, realtime traffic requires that variations in delay time of packet transmission be small. Therefore, a dynamic jitter buffer is often provided in a receiving device in order to accommodate a rapid change in average delay caused by rerouting. Such a dynamic jitter buffer inserts artificially generated packets, often noise packets, to increase the amount of buffer when average delay time of realtime traffic has increased. When average delay time has decreased, the dynamic jitter buffer discards normal packets to decrease the amount of buffer. Accordingly, a rapid increase or decrease in delay time associated with rerouting steeply increases or decreases the amount of buffer and, because the amount of noise packets inserted in the buffer or the number of packet discarded increases, noise increases.

Another problem with the related-art traffic rerouting systems described above is that, when traffic is duplicated for a certain period of time during rerouting and the same traffic is transmitted through the old and new paths, the amount of traffic increases because of the same traffic flowing through both paths.

### SUMMARY OF THE INVENTION

An object of the present invention is to provide a traffic rerouting method capable of preventing a rapid change in average delay time without increasing the amount of traffic.

Another object of the present invention is to provide a traffic rerouting system capable of preventing a rapid change in average delay time without increasing the amount of traffic.

According to a first aspect of the present invention, there is provided a traffic rerouting method for rerouting traffic to be passed to a receiving end from an old path to a new path, including: rerouting the traffic by reducing the amount of traffic passing through the old route while at the same time increasing the amount of traffic passing through the new path.

According to a second aspect of the present invention, there is provided a traffic rerouting system rerouting traffic to be passed to a receiving end from an old path to a new path, including: a relaying device capable of transferring packets to the receiving end through the new path and the old path; and a transfer percentage designator directing, when rerouting occurs, the relaying device to decrease the amount of traffic passing through the old path while at the same time to increase the amount of traffic passing through the new path.

According to the present invention, when traffic, especially realtime traffic, is rerouted, the amount of traffic passing through the old path is decreased while, at the same time, increasing the amount of traffic passing through the new path. In doing this, the traffic is not duplicated so that the total amount of traffic does not increase. In particular, the amount of traffic passing through the old path is gradually decreased while gradually increasing the amount of traffic passing through the new path. Thus, the amount of traffic is not increased and a rapid change in average delay time at the receiving end can be inhibited. According to the present invention, for example the percentage of traffic that passes through an old path can be reduced in steps while the percentage of traffic that passes through a new path is increased in steps in such a manner that the sum of the amounts of traffic passing through both old and new paths is constant in each step.

Because the amount of traffic passing through the old path is gradually decreased while at the same time the amount of traffic passing through the new path is gradually increased in the configuration described above, a large difference in transmission delay time between the paths does not cause a steep change in the average delay time for packets that arrived at the receiving end through both paths. Furthermore, because rerouting is performed without duplicating traffic, the total amount of traffic does not increase and the instantaneous value of the amount of traffic also does not increase.

The above and other objects, features, and advantages of the present invention will become apparent from the following description based on the accompanying drawings which illustrate examples of preferred embodiments of the present invention.

### BRIEF DESCRIPTION OF THE DRAWINGS

FIG. 1 is a block diagram showing a configuration of a traffic rerouting system according to an exemplary embodiment of the present invention.

### DETAILED DESCRIPTION OF THE EXEMPLARY EMBODIMENTS OF THE INVENTION

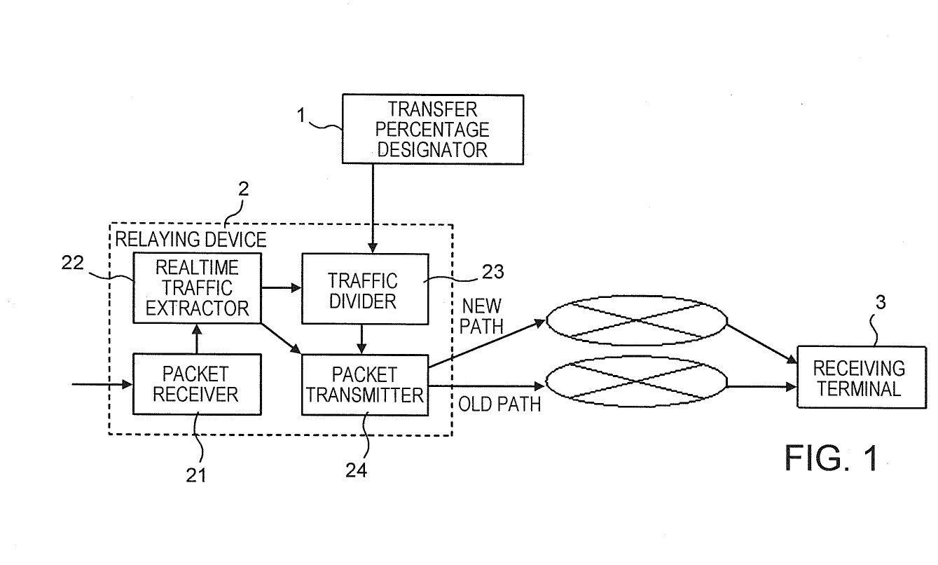

In the traffic rerouting system according to the exemplary embodiment shown in FIG. 1, multiple paths for transmitting realtime traffic are established between relaying device 2 and receiving terminal 3. It is assumed here that one of the paths is an old path and another is a new path. Connected to relaying device 2 is transfer percentage designator 1 which provides to relaying device 2 a designation of the percentages of amounts of traffic to be transferred to the old and new paths when rerouting is performed. Receiving terminal 3 includes a dynamic jitter buffer for accommodating variations in arrival time of packets.

Provided inside relaying device 2 are packet receiver 21, realtime traffic extractor 22, traffic divider 23, and packet transmitter 24. Packet receiver 21 has the function of receiving packets from an upstream device, not shown, and providing the received packets to realtime traffic extractor 22. Realtime traffic extractor 22 has the function of extracting realtime traffic such as audio and video traffic from packets received from packet receiver 21, providing the realtime traffic to traffic divider 23, and providing non-realtime traffic to packet transmitter 24. Traffic divider 23 has the function of dividing packets in realtime traffic into two groups, those to be transferred to an old path and those to be transferred to a new path in proportions specified by transfer percentage designator 1, and providing the divided packets to packet transmitter 24. Packet transmitter 24 has the function of transferring the packets divided at traffic divider 23 to an old path or a new path according to an instruction from traffic divider 23. Packet transmitter 24 also has the function of transferring non-realtime traffic sent from realtime traffic extractor 22 to an old path or a new path.

When rerouting occurs in the traffic rerouting system, transfer percentage designator 1 directs relaying device 2 to gradually reduce the percentage of packets to be transferred to the old path and increase the percentage of packets to be transferred to the new path. Consequently, relaying device 2 transfers packets, particularly realtime traffic packets, received from an upstream device, not shown, to the old path and the new path in specified proportions in accordance with the designation by transfer percentage designator 1. Receiving terminal 3 will receive traffic from both of the old and new paths.

An operation of the exemplary embodiment will be described below in further detail.

Transfer percentage designator 1 is notified of occurrence of rerouting by an indication by a human administrator or maintenance person, or other means, not shown. The means may be, for example, means for detecting that a condition for rerouting holds. When such means has detected degradation of communication quality, that is, an increase in a bit error rate, reduction in light intensity in optical communication, or reduction in radio wave intensity in radio communication, or predictor of degradation of communication quality, the means determines that it may be impossible to maintain the communication quality of the path currently being used, creates a new path and directs transfer percentage designator 1 to make switching to the new path.

When rerouting occurs, transfer percentage designator 1 directs traffic divider 23 in relaying device 2 to gradually decrease the percentage of packets to be transferred to the old path and increase the percentage of packets to be transferred to the new path. For example, transfer percentage designator 1 directs traffic divider 23 to transfer 90% of packets to the old path and 10% to the new path for the first 10 seconds after rerouting. Transfer percentage designator 1 directs to transfer 80% of packets to the old path and 20% to the new path for the next 10 seconds following the first 10 seconds, and to transfer 70% of packets to the old path and 30% to the new path for the next 10 seconds following the second 10 seconds and so on to gradually change the percentage of traffic transferred to the old path until the percentage reaches 0%.

In this example, the gradual change in the percentage of packets to be transferred to each path consists of total ten times of stepwise changes in the percentage. However, the number of times of the stepwise changes is not limited to ten. The number of times of the stepwise changes may be, for example, four, eight, fifteen or more. Alternatively, the percentage of packets to be transferred to each path may linearly change without stepwise changes.

Traffic divider 23 selects packets to be transferred to the old path and packets to be transferred to the new path from among the packets included in the realtime traffic extracted by realtime traffic extractor 22 so that the percentages designated by transfer percentage designator 1 are reached, and provides the packets to packet transmitter 24 along with a specification of the paths to which the packets are to be transferred. Packet transmitter 24 transfers the individual packets to the specified path (i.e., the new path or old path).

In the exemplary embodiment as described above, the amount of traffic passing through the old path gradually decreases while at the same time the amount of traffic passing through the new path gradually increases. Therefore a rapid change in average delay time observed by receiving terminal 3 can be prevented without increasing the total amount of traffic.

While transfer percentage designator 1 is provided separately from relaying device 2 in the traffic rerouting system of the exemplary embodiment described above, transfer percentage designator 1 may be provided within relaying device 2.

Realtime traffic extracted at realtime traffic extractor 22 may be further separated into flows and the amounts of traffic to be transmitted over the old and new paths may be specified for each of the separate flows.

In another exemplary embodiment of the present invention, when rerouting traffic, realtime traffic may be extracted from traffic to be transferred to the receiving end and, for the extracted realtime traffic, the amount of realtime traffic passing through the old path may be decreased while at the same time increasing the amount of realtime traffic passing through the new path. In this case, the extracted realtime traffic may be separated into flows and the amount of traffic to be transmitted over the old and new paths may be specified for each of the separate flows. In yet another exemplary embodiment, an instruction from a maintenance person or degradation of the communication quality of the path may be detected, a new path may be set or established, and switching to the new path may be made thereby accomplishing traffic rerouting.

In another exemplary embodiment of the present invention, preferably a packet receiver receiving packets from an upstream device, a traffic divider dividing packets into packets to be transferred to the old path and packets to be transmitted to the new path in proportions specified by a transfer percentage designator, and a packet transmitter transferring the packets divided at the traffic divider to the old path or the new path according to an instruction from the traffic divider are provided in a relaying device of a traffic rerouting system. In this case, a realtime traffic extractor which extracts realtime traffic from packets received at the packet receiver may be provided in the relaying device and the traffic divider may divide packets in the realtime traffic into packets to be transmitted to the old path and packets to be transmitted to the new path.

While exemplary embodiments of the present invention have been described using specific terms, such description is for illustrative purposes only, and it is to be understood that changes and variations may be made without departing from the spirit or scope of the following claims.

What is claimed is:

1. A traffic rerouting method for rerouting traffic to be passed to a receiving end from an old path to a new path, comprising:
rerouting the traffic by reducing amount of traffic passing through the old route while at the same time increasing amount of traffic passing through the new path.

2. The method according to claim 1, further comprising:
extracting realtime traffic from traffic to be transferred to the receiving end and decreasing amount of traffic, for the extracted realtime traffic, that passes through the old path while at the same time increasing amount of traffic, for the extracted realtime traffic, that passes through the new path.

3. The method according to claim 2, comprising separating the extracted realtime traffic into flows and, for each of the separated flows, specifying amount of traffic passing through the old path and the amount of traffic passing through the new path.

4. The method according to claim 1, wherein an instruction from a maintenance person or degradation of communication quality is detected to set the new path and rerouting is performed.

5. A traffic rerouting system rerouting traffic to be passed to a receiving end from an old path to a new path, comprising:
a relaying device capable of transferring packets to the receiving end through the new path and the old path; and
a transfer percentage designator directing, when rerouting occurs, the relaying device to decrease amount of traffic passing through the old path while at the same time to increase amount of traffic passing through the new path.

6. The system according to claim 5, wherein the relaying device comprises:
a packet receiver receiving packets from an upstream device;
a traffic divider dividing packets into packets to be transferred to the old path and packets to be transferred to the new path in proportions specified by the transfer percentage designator; and
a packet transmitter transferring the packets divided by the traffic divider to the old path or the new path in accordance with an instruction from the traffic divider.

7. The traffic rerouting system according to claim 6, further comprising:
a realtime traffic extractor extracting realtime traffic from packets received at the packed receiver,
wherein the traffic divider divides the packets in the realtime traffic into packets to be transferred to the old path and packets to be transferred to the new path.
